(19) United States
(12) Patent Application Publication
(10) Pub. No.: US 2008/0140431 A1
(43) Pub. Date: Jun. 12, 2008

(54) Method of performing an agricultural work operation using real time prescription adjustment

(76) Inventors: Noel Wayne Anderson, Fargo, ND (US); Mark William Stelford, Sycamore, IL (US); Stephen Michael Faivre, Kingston, IL (US)

Correspondence Address: DEERE & COMPANY, ONE JOHN DEERE PLACE, MOLINE, IL, 61265, US

(21) Appl. No.: 11/635,191

(22) Filed: Dec. 7, 2006

(51) Int. Cl. G06Q 50/00

(52) U.S. Cl. 705/1

(57) ABSTRACT

A method of performing an agricultural work operation includes the steps of: creating a prescription for a work operation in a geographic area; determining an estimated state for the geographic area; collecting real time data corresponding to an actual state for the geographic area; comparing the estimated state with the actual state; modifying the prescription, if the actual state varies from the estimated state by a threshold amount; and executing the work operation in the geographic area using the prescription.

### FIELD OF THE INVENTION

The present invention relates to a method of performing a field operation in a geographic area such as a field, and, more particularly, to a method of performing such a field operation using a custom prescription for the geographic area.

### BACKGROUND OF THE INVENTION

An agricultural enterprise may be divided into different farms, and different fields within each farm. Whole field and site-specific field operation prescriptions may be generated prior to going to the field to perform those operations. The drawback to this approach is that if new information becomes available while a machine is en route to or already in the field, it is very difficult, if not impossible, to adjust the prescription. Such new information may result from data that is released by private companies or government agencies, humans and/or “scouting robots” that are active in the field just prior to the machine arriving, or from “look ahead” sensors mounted on the machine itself. An example of this just-in-time data arrival scenario is application of a cotton growth inhibitor (e.g., PIX). The sprayer may have already left its base when newly processed aerial imagery arrives to generate an application map with high, medium, low, and zero treatments. The actual rates associated with high, medium, and low may not be determined until a human crop scout or a machine mounted sensor identifies the actual plant heights associated with the high, medium, and low treatment regions of the field.

What is needed in the art is a method of updating a prescription in real time as a work machine is enroute to or is performing a work operation according to a prescription for that geographic area.

### SUMMARY OF THE INVENTION

The invention in one form is directed to a method of performing an agricultural work operation, including the steps of: creating a baseline plan for a geographic area; determining an estimated field state for the geographic area; creating a prescription for a work operation for the geographic area, dependent upon the baseline plan and the estimated field state; collecting real time data corresponding to an actual field state for the geographic area; comparing the estimated field state with the actual field state; modifying the prescription, if the actual field state varies from the estimated field state by a threshold amount; and executing the work operation using the prescription.

The invention in another form is directed to a method of performing an agricultural work operation, including the steps of: creating a prescription for a work operation in a geographic area; determining an estimated state for the geographic area; collecting real time data corresponding to an actual state for the geographic area; comparing the estimated state with the actual state; modifying the prescription, if the actual state varies from the estimated state by a threshold amount; and executing the work operation in the geographic area using the prescription.

### BRIEF DESCRIPTION OF THE DRAWINGS

FIG. 1 is a data flow diagram for an embodiment of the method of the present invention; and

FIGS. 2A and 2B together illustrate a flow chart of the method of the present invention of FIG. 1.

### DETAILED DESCRIPTION OF THE INVENTION

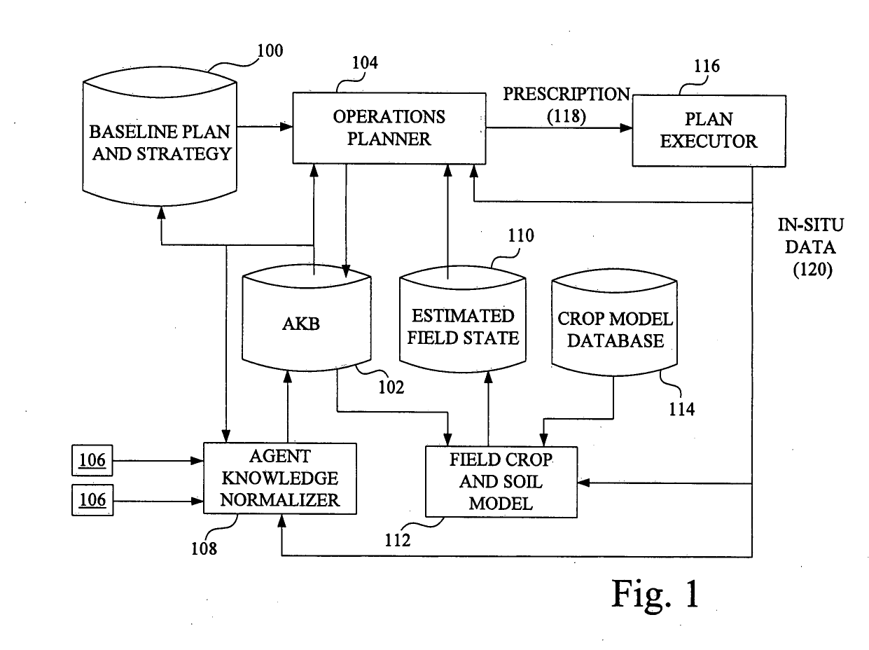

Referring now to the drawings, and more particularly to FIG. 1, there is shown a data flow diagram for an embodiment of the method of the present invention. A “Baseline Plan and Strategy” 100 is generated annually as part of farm operations, typically by March 1 of each year which is the typical start of the cropping year in much of North America. It is possible that over 70 management decisions may need to be made for each crop, and templates may be used to help the farm manager. Some of the management decisions may be fairly firm such as what kind of crop to plant in a given field. Other management actions, such as spraying for an insect or disease, may require certain conditions before action is taken. Besides the likely and contingent management activities for the year, the plan contains strategy information for the field such as “Minimize risk of loss for wet year”, “Maximize financial return for average year”, etc.

An “Agent Knowledge Base” (AKB) 102 contains public information which is made available to “Operations Planner” 104. AKB 102 obtains knowledge from a plurality of “Agents” 106 which are agents in the computer science sense of the word and can be either humans or machines. Knowledge from an Agent 106 enters AKB 102 through an “Agent Knowledge Normalizer” 108. The role of Agent Knowledge Normalizer 108 is to take the raw agent knowledge, scrub it for bad values, translate it into a normalized form for AKB 102, and in general make sure that what enters; AKB 102 is of good quality and ready for use. This sort of action is known for current high quality data and knowledge bases. A non-exhaustive list of agents 106 and their data includes:

1. Aerial images showing crop health such as cotton plant vigor correlated to plant height;

2. A human crop scout's report that is taken from a standard form on a tablet PC computer or Personal Data Assistant (PDA);

3. A robotic crop scout's data;

4. A textual analyzer that obtains text from agricultural web sites and submits key facts from what it “reads”;

5. Weather data from a private company;

6. Weather data from an on-farm weather network;

7. Crop reports from sources such as the USDA, university agricultural experiment stations, and county extension offices;

8. Information on agricultural chemicals and crop varieties from chemical companies and seed companies;

9. Data collected from machines that have visited the field in the current or past cropping years;

10. Field topographic information;

11. Field tile lines; and

12. Color and infrared images showing water and nutrient stress.

An “Estimated Field State” 110 is generated by one or more “Field Crop and Soil Models” 112. A non-exhaustive list of parameters making up the Estimated Field State include: soil type; soil moisture; soil compaction; soil temperature; soil nutrient levels, such as nitrogen-phosphorus-potassium (NPK), micro-nutrients, and organic matter; crop variety; crop growth stage; crop pest manifestation; and current crop yield potential. The Estimated Field State 110 may be as simple as “Time to plant” or very complex with more parameters than have been listed along with temporal projections of what the parameter values will be. For simplicity, the data used by the Field Crop and Soil Models is received from AKB 102, but it could also be stored in a separate “Crop Model Data Base” 114.

Operations Planner 104 and a “Plan Executor” 116 communicate via an “Operation Plan” or “Prescription” 118 and “In-situ Data” 120. Operations Planner 104 takes as input the Baseline Plan and Strategy 100, AKB 102, Estimated Field State 110, and In-Situ Data 120 to generate Prescription 118 in real-time (i.e., while the machine is enroute to or in the field) for use in the current field. The Prescription 118 is executed by Plan Executor 116 on the work machine which also collects data to be fed back to Operations Planner 104. The work machine may be of any suitable type for carrying out the work operation, such as a tractor, harvester, sprayer, etc.

Hardware and software implementations of the present invention include (but are not limited to):

1. One or more computers on board the machine running software implementations;

2. The Operations Planner 104 residing off the machine, the Plan Executor 116 residing on the machine, with the two connected by a high speed telematics link; and

3. The Operations Planner 104 and the Plan Executor 116 both residing on one or more computers off the machine, but controlling machine operation by a wireless network link.

A non-exhaustive list of site-specific agricultural applications of this invention include: deep tillage or variable depth tillage; tillage aggregate size and/or residue coverage control; population, depth, and/or variety control of planters; sprayer rate and/or formulation control; cotton growth inhibitor application; and irrigation control.

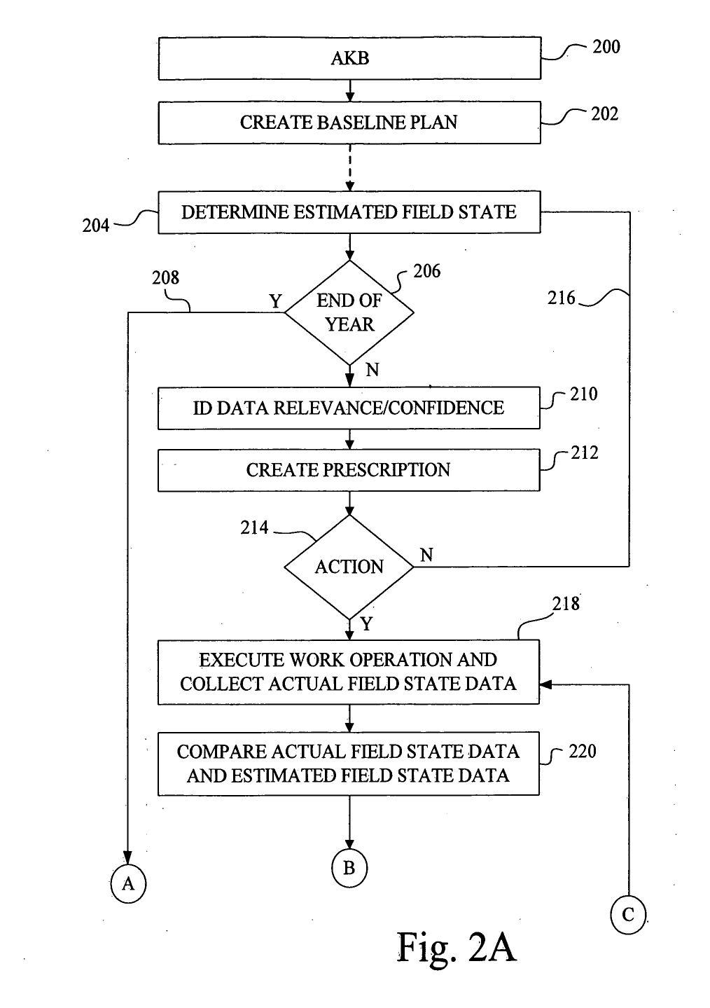

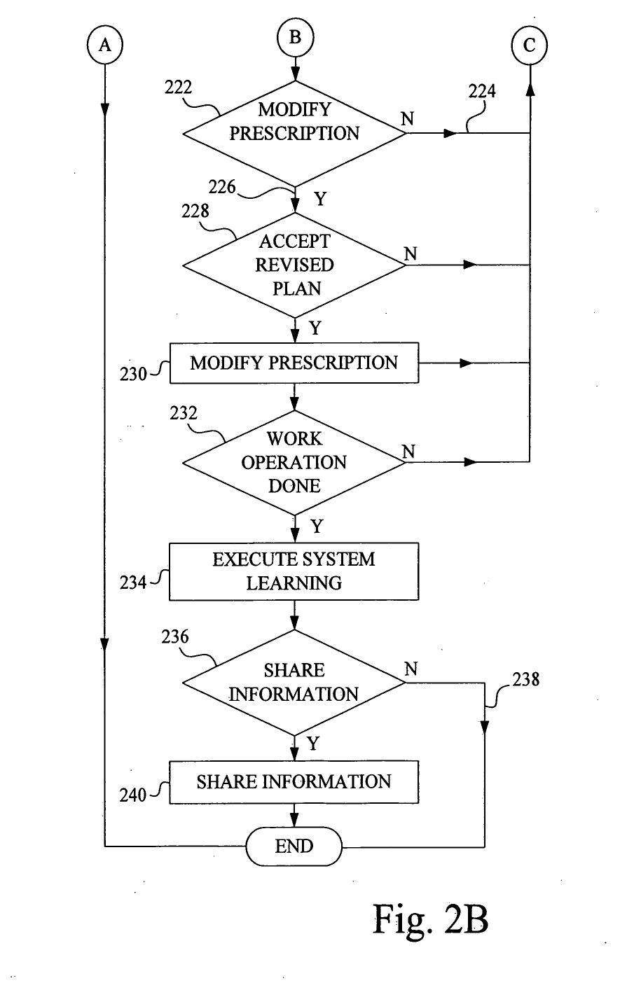

FIGS. 2A and 2B together illustrate a flow chart of the method of the present invention of FIG. 1. Other variants of control flow are possible, but the key sequenced actions are (1) a dynamic real-time change (2) that results in replanning (3) that is implemented while a work machine is still in particular geographic area (e.g., field). Initially, it is assumed that at the start of the year, the Baseline Plan and Strategy 100 as well as the AKB 102 have been set up (blocks 200 and 202, with dashed line from block 202).

In block 204, an estimated field state is determined corresponding to the particular state of the crop and/or soil. Relevant soil conditions include, but are not limited to, soil moisture and soil temperature. To predict values for soil conditions 28, the method may use a dynamic soil model, such as the Precision Agricultural-Landscape Modeling System (PALMS) developed under NASA's Regional Earth Science Application Center (RESAC) program. This program predicts soil moisture and soil temperature, as well as crop moisture and other variables, based on predicted weather conditions and measured soil conditions. This computer program is available under license for research or commercial use through the Wisconsin Alumni Research Foundation.

In contrast with the Baseline Plan & Strategy which is more of an operations wide type of plan which could include multiple farms, the crop and soil models are more specifically directed to a specific farm, a specific field within a farm, and/or a part of a field.

In block 206, a determination is made as to whether the current crop year has ended. If so, then no further work operations are necessary on the field and the process ends (line 208). Otherwise, the information is evaluated in block 210 for relevance and confidence. Identifying actionable information for a particular farm or field from all information available in an efficient manner is critical to supporting the work operation in real time. AKB 102 contains information collected from the current farm and its fields and the Baseline Plan and Strategy 100. The goal is to find information relevant for the current farm in the current year. A non-exhaustive list of factors to be considered in identifying relevant information include:

1. Crop—e.g., information on corn pests is less likely to be relevant to a soybean field than another corn field;

2. Proximity—e.g., information targeted to California farmers is less likely to be relevant to southern Minnesota farmers than, say, information targeted to northern Iowa farmers;

3. Tillage practices—e.g., some information is more relevant to no-till farmers than to farmers who do full tillage; and

4. Crop variety—e.g., Round-Up™ herbicide application information is of more interest to those who have planted tolerant crop varieties than to non-tolerant crop varieties.

Agent Knowledge Normalizer 108 is responsible for rating knowledge as it comes into the database on one or more dimensions. The relevance level would be 100% for information collected from the same land in the same year (farm, field, or subfield) for which information matches are being sought (i.e., the relevance of a field with itself is 1). Dryland corn in the midwest U.S. would likely have a correlation of near 0 with irrigated nuts grown in Australia. The distance, the seasons, the crops, etc. are about as different as they could be.

Besides relevance, other metrics may be generated for pieces of information. One example is a confidence level. One would likely place higher confidence in research results published by a nearby University experiment station than a casual comment gleaned from a weblog (Blog). As another example, a high resolution aerial photo would be rated higher than a “windshield” survey of a field for crop health, etc.

In both the iterative and event driven embodiments of the present invention, the relevant knowledge, as filtered by relevance, confidence, etc, is presented to Operations Planner 104. If there is new information, Operations Planner 104 creates and executes a prescription (block 212). At block 214, an operator is given an opportunity to manually override the prescription (line 216). If the operator chooses to proceed with the prescription, then the work operation is carried out according to the prescription and real time data is collected according to the actual field state (block 218).

During execution of the work operation, the data for the actual field state is compared to data for the estimated field state to determine if assumed input parameters were correct (block 222). If the current field state does not vary by a threshold amount from the estimated field state, then a decision is made to continue utilizing the current prescription (line 224) and control logic returns to execution of the prescription at block 218. On the other hand, if the current field state does vary by a threshold amount from the estimated field state, then a decision is made to modify the current prescription (line 226). The threshold value may be determined theoretically or empirically for a particular work operation and prescription.

In block 228 (optional), the operator is given an opportunity to reject the revised prescription, in which case the control logic returns to execution of the prescription at block 218. Otherwise, the prescription is modified based upon the real time in-situ data and the work operation is carried out using the modified prescription (block 230).

When the work operation is done (block 232), process learning takes place by sharing in-situ data gathered by the machine in the field with AKB 102 via Agent Knowledge Normalizer 108 (block 234). The shared information can be used by Operations Planner 104 and/or Field Crop and Soil Model(s) 112 for use in developing future prescriptions and models.

The field information can also optionally be shared externally with other farming operations with several different levels of sharing (decision block 236). If an operator chooses not to externally share information, then the process simply ends (line 238).

Information which is shared (block 240) can have sharing rights which are customized for each type of data and also for each recipient. “Information cooperatives” are envisioned where participants could benefit from the sharing of data. For example, if a farmer enters a field to do an operation, but it is too wet, neighbors with similar scheduled operations in similar fields could benefit by not going out and making the same discovery for themselves. The neighbors could also benefit from the soil moisture model learning from its error.

One implementation of the invention with four levels of sharing includes: none, public, practice, and full, defined as follows:

1. None—no information is shared at all;

2. Public—information available by roadside observation or other public sources such as field location, soil type, topography, crop, date of field operations, etc;

3. Practice—information such as tillage depth, planting depth, and chemical application rates; and

4. Full—all information including business dollars and cents. As mentioned earlier, benefits of sharing data include avoiding needless field trips if conditions are bad, model and planner learning from a larger experience base, and benchmarking one's own operation against the aggregate sharing community.

While there is economic value to making real-time adjustments in a single field, the value can be increased by (1) immediately sharing the observed field conditions with others, and (2) sharing field operations and the end of year yield to understand how different practices for similar fields turned out. The first type of sharing helps optimize current year action while the latter helps with future year's strategic decisions such as no-till vs till, hybrid selection, etc.

As farms increase in size, unit product margins decline, and farm operations increase in complexity, artificial intelligence and information automation technology will be needed to optimize farming operations to ensure profitability. The amount of information to be evaluated for relevance and turned into executable plans is becoming too great. Additional value is added through automated learning from experience and sharing of information.

Because of the business importance of the data, the prevalent concerns of privacy, authentication and data security may also be included when evoking the data sharing option. Examples of data transmissions with authentication and security include digital signatures and encryption.

As an example of a practical application of the present invention, assume a farmer has a field of soybeans in Mist County, Minn. The Baseline Plan includes spraying if soybean aphids are discovered. An agent that monitors University of Minnesota agricultural publications has previously collected information that if soybean aphids are detected, the soybeans should be sprayed with chemical C at rate R. Because the information is for the state of Minnesota, its relevance is rated high. Because the source of information is a university publication, its confidence is rated high.

The same agent later collects a report from an Agricultural Experiment Station in Mist County that aphids have been detected widely across the county. Because this information covers the whole county, its relevance is rated Very High and the confidence is High. The information about the aphids triggers the contingent spraying part of the Baseline Plan. As the Operations Planner plans for spraying, it draws on other knowledge in AKB 102 including:

Fuel, labor, machinery, chemical, etc. that indicated that spraying should only be done on parts of the field where current yield potential is greater than or equal to 25 bushels per acre.

The current crop model is used to identify areas of the field that should be sprayed given the current yield potential. These areas would have canopy closure of 75% or better.

The spraying is scheduled and the spraying map is sent to Plan Executor 116 on the Sprayer. Based on detected crop canopy closure and plant height using appropriate in-situ data sensors, the crop is better than modeled. The Operations Planner 104 is invoked. More chemical will be needed to spray more acres. A new map is generated and sent to the sprayer and sprayer tending is scheduled.

At the end of spraying, the plant health as observed by the sprayer is fed back into AKB 102. From there it is dispatched to Field Crop Model 114 for a learning phase to improve the model for that crop in that field. The spraying date, field size, and field location are shared with a community information cooperative where it is aggregated for use in generating reports during the rest of the year. In the current week's report, the data will show up in the section “Acres sprayed for aphids in Mist County” and a map showing where those acres are. In the end of year report, the data will show up in a yield comparison of soybeans sprayed versus those not sprayed.

From the foregoing, it should be apparent that the present invention automates dynamic planning and replanning for a farm operation based on Field Crop and Soil Models as well as information gathered from within a farm operation and from without via agents. The agent information is normalized in format and assessed based on factors such as relevance for a given farm/field and confidence in the information. An Operations Planner compares a new plan based on new information with the current plan and determines if the new plan should replace the current plan for use by the Plan Executor. Data collected by the Plan Executor is fed back to the system for learning and sharing.

While the present invention has been described above with respect to geographic areas in the form of fields or areas within a field, it is also to be understood that the present invention can be used within other types of geographic areas in an agricultural operation. For example, the present invention can be used to carry out a work operation within a hydroponic growing environment.

Having described the preferred embodiment, it will become apparent that various modifications can be made without departing from the scope of the invention as defined in the accompanying claims.

1. A method of performing an agricultural work operation, comprising the steps of:
creating a baseline plan for a geographic area;
determining an estimated field state for said geographic area;
creating a prescription for a work operation for said geographic area, dependent upon said baseline plan and said estimated field state;
collecting real time data corresponding to an actual field state for said geographic area;
comparing said estimated field state with said actual field state;
modifying said prescription, if said actual field state varies from said estimated field state by a threshold amount; and
executing said work operation using said prescription.

2. The method of performing an agricultural work operation of claim 1, including the further step of sharing selected information relating to said work operation.

3. The method of performing an agricultural work operation of claim 2, wherein said selected information includes one of public information, practice information, and full information.

4. The method of performing an agricultural work operation of claim 3, wherein said public information includes at least one of field location, soil type, topography, crop type, and date of work operation;
said practice information includes at least one of tillage depth, planting depth, and chemical application rates; and
said full information includes all information including business monetary information pertaining to said work operation.

5. The method of performing an agricultural work operation of claim 1, wherein said step of creating said baseline plan is based upon an agent knowledge base, said agent knowledge base including publically available data.

6. The method of performing an agricultural work operation of claim 5, wherein said agent knowledge base includes at least one of: aerial images; a human crop scout report; robotic crop scout data; textual analyzer obtaining information from internet web sites; weather data from a private company; weather data from an on-farm network; crop reports from government and university sources; information on agricultural chemicals; information on crop varieties; data collected from work machines previously executing a field operation in said geographic area; field topographic information; and field tile lines.

7. The method of performing an agricultural work operation of claim 5, wherein said baseline plan is created by ranking said data from said agent knowledge base for relevance and confidence.

8. The method of performing an agricultural work operation of claim 5, wherein said step of creating said baseline plan is based upon at least one field crop and soil model.

9. The method of performing an agricultural work operation of claim 1, wherein said estimated field state is based upon information including at least one of: soil type, soil moisture, soil compaction, soil temperature, soil nutrient levels, crop variety, crop growth stage, crop pest manifestation, and current crop yield potential.

10. The method of performing an agricultural work operation of claim 1, wherein said work operation includes:
at least one of deep tillage and variable depth tillage;
at least one of tillage aggregate size and residue coverage control;
at least one of seed population, seed depth and seed variety control;
at least one of sprayer rate and formulation control; and
cotton growth inhibitor application.

11. The method of performing an agricultural work operation of claim 1, wherein said work operation is a field operation.

12. The method of performing an agricultural work operation of claim 1, wherein said geographic area comprises one of a field and a part of a field.

13. A method of performing an agricultural work operation, comprising the steps of:
creating a prescription for a work operation in a geographic area;
determining an estimated state for said geographic area;
collecting real time data corresponding to an actual state for said geographic area;
comparing said estimated state with said actual state;
modifying said prescription, if said actual state varies from said estimated state by a threshold amount; and
executing said work operation in said geographic area using said prescription.

14. The method of performing an agricultural work operation of claim 13, including the further step of sharing selected information relating to said work operation.

15. The method of performing an agricultural work operation of claim 14, wherein said selected information includes one of public information, practice information, and full information.

16. The method of performing an agricultural work operation of claim 15, wherein said public information includes at least one of field location, soil type, topography, crop type, and date of work operation;
said practice information includes at least one of tillage depth, planting depth, and chemical application rates; and
said full information includes all information including business monetary information pertaining to said work operation.

17. The method of performing an agricultural work operation of claim 13, wherein said step of creating said prescription is based upon an agent knowledge base, said agent knowledge base including publically available data.

18. The method of performing an agricultural work operation of claim 17, wherein said agent knowledge base includes at least one of: aerial images; a human crop scout report; robotic crop scout data; textual analyzer obtaining information from internet web sites; weather data from a private company; weather data from an on-farm network; crop reports from government and university sources, information on agricultural chemicals; information on crop varieties; data collected from work machines previously executing a field operation in said geographic area; field topographic information; and field tile lines.

19. The method of performing an agricultural work operation of claim 17, wherein said prescription is based upon a baseline plan, said baseline plan being created by ranking said data from said agent knowledge base for relevance and confidence.

20. The method of performing an agricultural work operation of claim 17, wherein said step of creating said baseline plan is based upon at least one field crop and soil model.

21. The method of performing an agricultural work operation of claim 13, wherein said estimated state is based upon information including at least one of: soil type, soil moisture, soil compaction, soil temperature, soil nutrient levels, crop variety, crop growth stage, crop pest manifestation, and current crop yield potential.

22. The method of performing an agricultural work operation of claim 13, wherein said work operation includes:
at least one of deep tillage and variable depth tillage;
at least one of tillage aggregate size and residue coverage control;
at least one of seed population, seed depth and seed variety control;
at least one of sprayer rate and formulation control; and
cotton growth inhibitor application.

23. The method of performing an agricultural work operation of claim 13, wherein said work operation is a field operation.

24. The method of performing an agricultural work operation of claim 13, wherein said geographic area comprises one of a field and a part of a field.
